(19) United States
(12) Patent Application Publication
(10) Pub. No.: US 2026/0304294 A1
(43) Pub. Date: Oct. 1, 2026

(54) SIDELINK SYNCHRONIZATION SIGNAL BLOCK WIDEBAND REPETITION INDICATION

(71) Applicant: QUALCOMM Incorporated, San Diego, CA (US)

(72) Inventors: Chih-Hao LIU, San Diego, CA (US); Jing SUN, San Diego, CA (US); Giovanni CHISCI, San Diego, CA (US); Stelios STEFANATOS, San Diego, CA (US)

(21) Appl. No.: 19/481,174

(22) PCT Filed: Jun. 14, 2024
(86) PCT No.: PCT/US2024/034138

§ 371 Date: Nov. 4, 2025

(30) Foreign Application Priority Data
Jun. 21, 2023 (GR) 20230100499

(51) Int. Cl. H04W 48/08; H04L 1/18

(52) U.S. Cl. CPC H04W 48/08; H04L 1/18

(57) ABSTRACT

Certain aspects of the present disclosure provide techniques for sending, using a first frequency, a legacy sidelink synchronization signal block (S-SSB) comprising an indication of a frequency repetition of the legacy S-SSB, and sending, using one or more frequencies different from the first frequency, one or more repetitions of the legacy S-SSB.

### CROSS-REFERENCE TO RELATED APPLICATIONS

This application claims the benefit of and priority to Greece Patent Application No. 20230100499 filed on Jun. 21, 2023, the disclosures of which is incorporated herein by reference in its entirety.

### INTRODUCTION

### Field of the Disclosure

Aspects of the present disclosure relate to wireless communications, and more particularly, to techniques for indicating frequency repetition of legacy sidelink synchronization signal blocks (S-SSBs).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes sending, using a first frequency, a legacy sidelink synchronization signal block (S-SSB) comprising an indication of a frequency repetition of the legacy S-SSB; and sending, using one or more frequencies different from the first frequency, one or more repetitions of the legacy S-SSB.

Another aspect provides a method for wireless communication by a user equipment (UE). The method includes receiving a legacy sidelink synchronization signal block (S-SSB) comprising an indication of a frequency repetition of the legacy S-SSB; and receiving one or more frequency repetitions of the legacy S-SSB.

Other aspects provide: one or more apparatuses operable, configured, or otherwise adapted to perform any portion of any method described herein (e.g., such that performance may be by only one apparatus or in a distributed fashion across multiple apparatuses); a one or more non-transitory, computer-readable media comprising instructions that, when executed by one or more a processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts a wireless communication frame structure having repetitions of legacy S-SSB.

FIG. 6 depicts a method for wireless communications.

FIG. 7 depicts another method for wireless communications.

FIG. 8 depicts aspects of an example communications device.

### DETAILED DESCRIPTION

Aspects of the present disclosure provide apparatuses, methods, processing systems, and computer-readable mediums for indicating frequency repetition of legacy S-SSBs.

Sidelink (SL) generally refers to direct communication between wireless apparatuses (e.g., UEs) without the need for data to go through a network. For example, sidelink is utilized in Vehicle-to-Everything (V2X) communications, including Vehicle-to-vehicle (V2V), Vehicle-to-Network (V2N) or Vehicle-to-Infrastructure (V2I), Vehicle-to-Road Side Unit (V2R), and Vehicle-to-Pedestrian (V2P).

Sidelink communications are often performed between UEs that are mobile or stationary only for a transient period of time. Sidelink communications can extend coverage to UEs that are out of a network coverage and/or for communication directly between UEs without connection to a network.

In various aspects, establishing sidelink communications between UEs includes transmitting synchronization information, such as a legacy sidelink synchronization signal block (S-SSB), from one UE (e.g., a SyncRef node) to one or more nearby UEs. In various aspects, the legacy S-SSB includes a physical sidelink broadcast channel (PSBCH), sidelink primary synchronization signal (S-PSS), and a sidelink secondary synchronization signal (S-SSS). In general, synchronization information includes time and frequency information that nearby UEs may receive to perform communication synchronization with the UE transmitting the S-SSB. This enables the nearby UEs to then establish SL communication with the UE transmitting the S-SSB.

The S-PSS and S-SSS are jointly referred to as the sidelink synchronization signal (SLSS). The SLSS is used for time and frequency synchronization. By detecting the SLSS sent by a SyncRef node, a UE is able to synchronize to the SyncRef node and estimate the beginning of the frame and carrier frequency offsets. The UE can use the SL timing reference provided by the SyncRef node for SL transmissions with nearby UEs that are using the same timing reference.

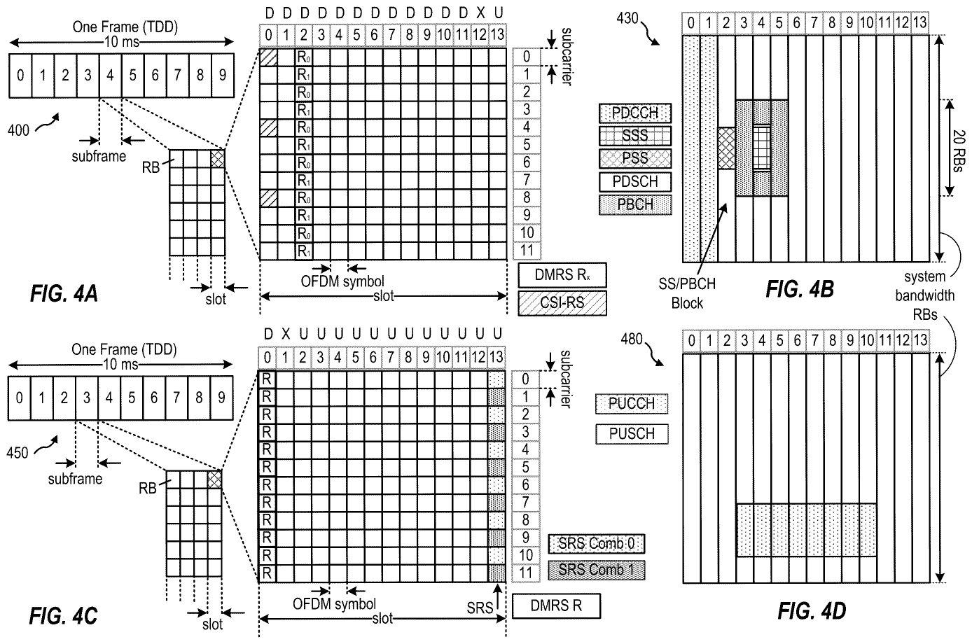

Under existing standards, for example, NR V2X, sidelink communications are pre-configured to occupy a sidelink bandwidth part (SL BWP) of a carrier bandwidth. A BWP is a contiguous portion of bandwidth within the carrier bandwidth where a single numerology is employed. Sidelink UE transmissions and receptions are contained within the SL BWP and employ the same numerology. Thus, all physical channels, reference signals, and synchronization signals in NR V2X sidelink are transmitted within the SL BWP. This also means that in the sidelink, a UE is not expected to receive or transmit in a carrier with more than one numerology. The SL BWP is divided into common resource blocks (RBs), which are discussed in more detail herein with reference to at least FIGS. 4A, 4B, 4C, and 4D.

Legacy S-SSBs are not frequency multiplexed with any other sidelink physical channel within the SL BWP. In the frequency domain, the legacy S-SSB generally spans 11 common RBs (e.g., as referred to herein as the legacy 11 RB S-SSB) within the SL BWP. Since an RB consists of 12 subcarriers, the legacy S-SSB bandwidth spans 11×12=132 subcarriers. The frequency location of a legacy S-SSB is generally pre-configured within a SL BWP. As a result, a UE does not perform blind detection in the frequency domain to find the legacy S-SSB. Accordingly, conventional UEs operating in sidelink are not configured to search or monitor for the legacy S-SSB outside of the pre-configured frequency domain.

Sidelink communications may be subject to Occupied Channel Bandwidth (OCB) requirements in certain regions to promote efficient use of channels. The OCB may be defined in some cases as the channel bandwidth containing 99% of the signal power with bandwidth outside of which has a maximum of 1% of the emissions (e.g., 0.5% on each side) and an OCB requirement may mandate that the OCB be larger than a percentage of the Nominal Channel Bandwidth (NCB) (i.e., the channel width).

As such, a technical problem arises with transmissions where the SyncRef node does not transmit sufficient additional data with the legacy S-SSB to meet OCB requirements. That is, such transmissions fail to meet OCB requirements and moreover, fail to make efficient use of the channel. A technical solution to meeting the OCB requirement is to cause the legacy S-SSB to be repeated across the frequency domain, thereby filling the required bandwidth. In some aspects, the frequency repetitions are accomplished by introducing gaps between the repetitions to meet OCB requirements. The gaps are implemented to define the bandwidth outside of the channel which, for example, may contain only 1% of the emissions. As one instance of the legacy S-SSB is 11 RB, the gap is configured so that, for example, two copies of the legacy S-SSB occupy at least 16 MHz so that 99% of the energy is within 16 MHz. Additionally, the gap can be implemented so that a receiver UE can implement an RX filter to extract one copy of the legacy S-SSB for sync search operations. That is, the gap can provide an indication of distinct repetitions of the legacy S-SSB so that an RX filter may extract individual repetitions.

However, there is no efficient use of frequency repetitions of the legacy S-SSB without a receiver UE capable of utilizing the frequency repetitions of the legacy S-SSB. That is, a receiver UE cannot utilize the frequency repetitions of legacy S-SSB without being reconfigured or triggered to do so based on an indication that the network is configured to and/or actively providing a frequency repetition of the legacy S-SSB. Therefore, another technical solution described herein provides for an indication of a frequency repetition of the legacy S-SSB with a transmission of the legacy S-SSB.

A technical benefit of indicating and providing frequency repetitions of the legacy S-SSB is that a receiver UE's reception is improve because there is more signal power. For example, a receiver UE may combine the frequency repetitions of the legacy S-SSB to meet a detection threshold necessary to achieve time and frequency synchronization as well as frame and slot synchronization.

Additionally, frequency repetitions of the legacy S-SSB increases the TX power for the legacy S-SSB and thereby changes (e.g., extends) the effective coverage area for sidelink communications. It should be noted though, that a power spectral density (PSD) limit may cap the total transmit power from a given legacy S-SSB. Therefore, to achieve higher TX power, more than one frequency repetition of the legacy S-SSB may be used. As a result, the TX UE may selectively adjust the effective coverage area through the number of frequency repetitions of the legacy S-SSB.

For example, in one aspect, an apparatus such as a UE, is configured to send, using a first frequency, a legacy S-SSB comprising an indication of a frequency repetition of the legacy S-SSB and send, using one or more frequencies different from the first frequency, one or more repetitions of the legacy S-SSB. In a corresponding aspect, a receiving apparatus such as a receiving UE is configured to receive a legacy S-SSB comprising an indication of a frequency repetition of the legacy S-SSB and receive one or more frequency repetitions of the legacy S-SSB. In response to receiving the indication, the receiving UE detects the indication of the frequency repetition in the legacy S-SSB and combines the one or more frequency repetitions based on detection of the indication. However, although an indication is provided, in some aspects, a receiving UE may choose not to combine the one or more frequency repetitions. The receiving UE may choose not to combine the one or more frequency repetitions, for example, because the quality of radio link meets a predetermined threshold.

Aspects described herein may thus be used to improve synchronization reliability and range of sidelink based communication.

### Introduction to Wireless Communications Networks

The techniques and methods described herein may be used for various wireless communications networks. While aspects may be described herein using terminology commonly associated with 3G, 4G, 5G, 6G and/or other generations of wireless technologies, aspects of the present disclosure may likewise be applicable to other communications systems and standards not explicitly mentioned herein.

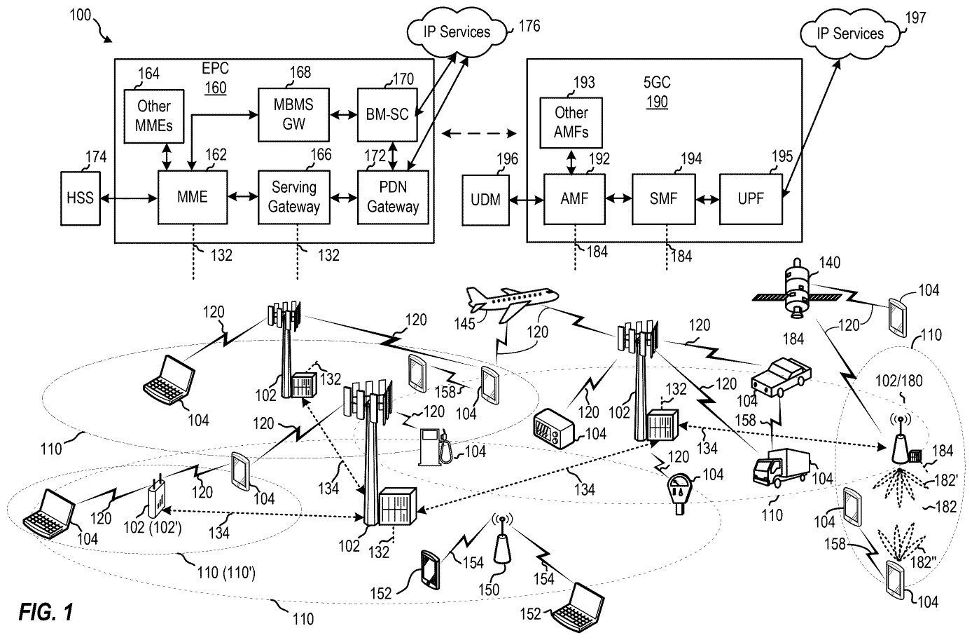

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

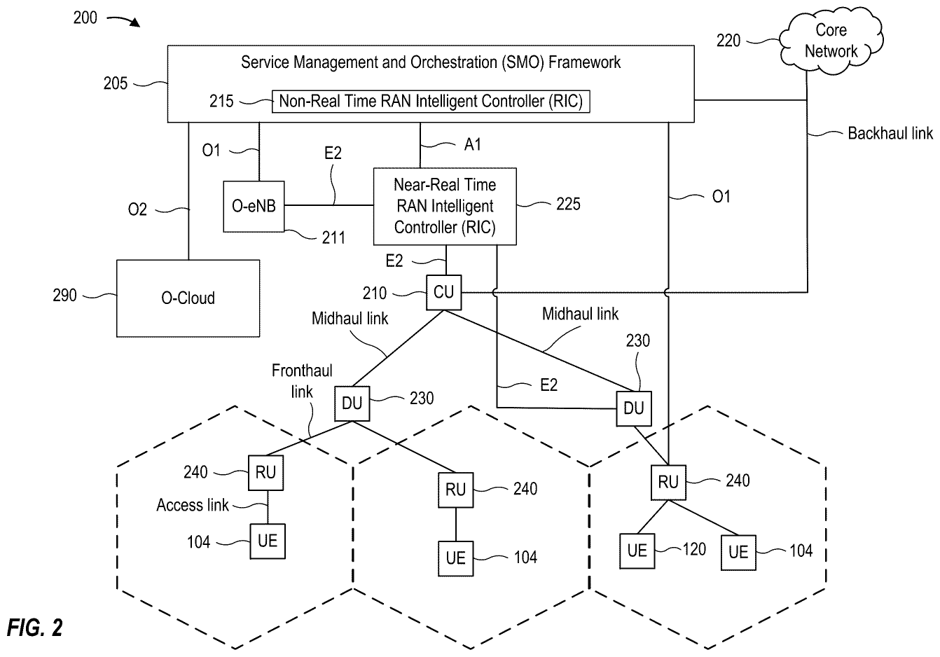

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mm Wave”). A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

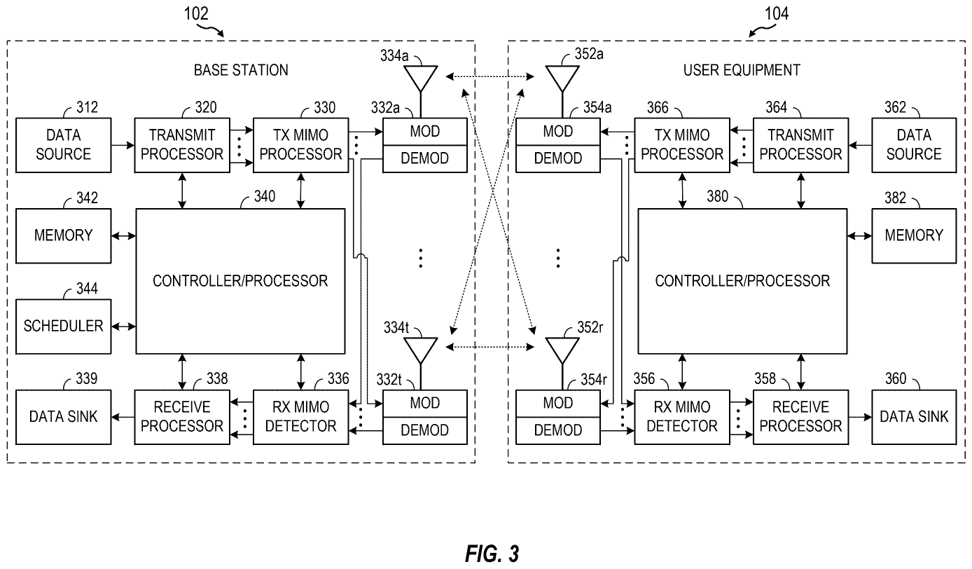

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology 82 =5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Indicating Frequency Repetitions of a Legacy Sidelink SSB

Aspects of the present disclosure relate to indicating frequency repetition (e.g., repetition in the frequency domain) of a legacy sidelink SSB. For example, in various aspects described herein, a legacy sidelink SSB may be repeated a configured number (e.g., N) of times in the frequency domain, and an indication may be sent from the UE transmitting the legacy S-SSB repetitions to the receiver of the legacy S-SSB repetitions so that the receiver may exploit such repetitions.

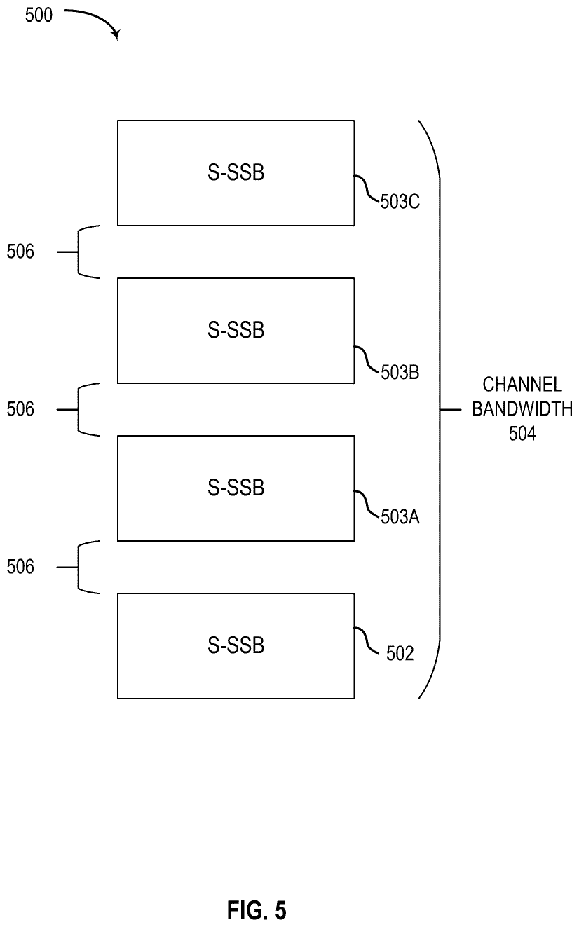

FIG. 5 depicts an example of a wireless communication structure 500 including a legacy S-SSB 502 and repetitions of legacy S-SSB 503A-C. For example, as shown in FIG. 5 multiple legacy S-SSB 502, 503A-C transmissions are depicted across a channel bandwidth 504. For example, the channel bandwidth may be 20 MHz. The transmissions of the legacy S-SSB 502 repetitions may be transmitted with a gap 506 in frequency between the legacy S-SSB 502 and each of the repetitions of the legacy S-SSB 503A-C. The repetitions of the legacy S-SSB 502 in combination with the gap 506 between the repetitions may be configured so that the transmission meets an OCB threshold. In some aspects the size of the gap 506 between repetitions is pre-configured or predefined. For example, one aspect of two repetitions of the legacy S-SSB comprising 11 RBs may have a gap 506 equal to or greater than 22 RBs between each repetition. In another aspect, there may be four repetitions of the legacy S-SSB which include a gap 506 of 1 RB between each repetition. In other aspects, the gap 506 may be omitted (e.g., set to zero).

While for regions where there is no OCB requirement or there is a temporary OCB exemption, the legacy 11 RB (e.g., referring to the number of RBs described in FIGS. 4A and 4C) S-SSB waveform may provide for a robust and reliable synchronization signal for sidelink communications. However, a UE may decide to implement frequency repetition of the legacy S-SSB when there is a need for meeting a regulation. Even when there is a temporary OCB exception, the legacy S-SSB transmitting UE may choose to transmit one or more legacy S-SSB frequency repetitions to achieve a higher transmit power that is under a power spectral density (PSD) limit. The PSD limit caps the total transmit power for a given legacy S-SSB, so, to achieve higher transmit power, more than one frequency repetitions of the legacy S-SSB may be used.

Since there are at least two potential configurations that a transmitting UE may implement with respect to transmission of the legacy S-SSB (e.g., with and without repetitions), for a receiving UE to fully exploit the advantages of repetitions of the legacy S-SSB, the transmitting UE may be configured to provide an indication of frequency repetitions of the legacy S-SSB to a receiver UE. In some aspects, the repetition indication indicates the number of frequency repetitions of the legacy S-SSB and the size of the gap so that the frequency repetitions of the legacy S-SSB can be searched for and/or located by the receiver UE. In some aspects, the size of the gap may be pre-configured in the receiver UE.

In some aspects, the number of frequency repetitions of the legacy S-SSB can be fixed or dynamic. In the fixed case, the indication may simply indicate whether there is or is not repetition transmitted along with the legacy S-SSB. For example, the indication maybe provided by a single bit where one value indicates repetition and the other indicates no repetition. In the dynamic case, the indication may define the number of frequency repetitions with one or more bits. A receiver UE is capable of determining whether there is repetition upon receiving the indication, for example, which may be a single bit indication as described above. The indication may be a multi-bit indication that indicates both the presence of frequency repetition of the legacy S-SSB and based on the value of the multi-bit indication conveys the number of frequency repetitions of the legacy S-SSB.

In aspects, the indication can be implemented in different ways. For example, the indication can be comprised within a physical sidelink broadcast channel (PSBCH) transmission. In another example, the indication of the frequency repetition of the legacy S-SSB is comprised within a master information block (MIB). In another example, the indication of the frequency repetition of the legacy S-SSB is comprised within a demodulation reference signal sequence sent on a physical sidelink broadcast channel. In some aspects the demodulation reference signal sequence is a scrambled demodulation reference signal sequence. Once a repetition indication is transmitted, the receiver of the transmission may expect the repetition to stay the same, e.g., for some period of time, or until further indication. For example, a further indication can indicate a change to the repetition scheme (e.g., the presence of repetitions and/or the number of repetitions).

In response to receiving a repetition indication, a receiver UE may be configured to combine the legacy S-SSB with the one or more frequency repetitions of the legacy S-SSB. The combination of legacy S-SSBs provides the technical benefit of an increase in overall received signal power, which can improve the detection rate of the synchronization information provided by the legacy S-SSB. Accordingly, improvements in detection of the synchronization information leads to extended effective coverage areas and reliability of the timing and frequency synchronization between UEs. That is, the increased total power associated with the received frequency repetitions of the legacy S-SSB improves reception of the legacy S-SSB by a receiver UE because there is more signal power. For example, a receiver UE may combine the frequency repetitions of the legacy S-SSB to meet a detection threshold necessary to achieve time and frequency synchronization as well as frame and slot synchronization. The additional energy of the transmission across multiple frequencies of the frequency domain thereby improves the decoding processes.

By default, in some aspects, the receiver UE would only search and/or monitor the legacy S-SSB in a predefined synchronization raster. When a detection of an indication of repetitions is made, for example, by a receiver UE, the receiver UE may search for the legacy S-SSB repetitions in other frequencies. A receiver UE that is capable of reading an indication present in the legacy S-SSB may then combine the frequency repetitions based on the repetition indication in the legacy S-SSB. However, if the receiver UE is not capable of reading the indication, the repetitions of the legacy S-SSB may have no effect on the particular receiver UE. As such, UEs capable of utilizing frequency repetitions of the legacy S-SSB and UEs that are not capable of utilizing frequency repetitions of the legacy S-SSB can coexist in sidelink communications together and optionally with other UEs. That said, in some aspects, the receiver UE may choose or be configured for a default behavior (e.g., not to combine frequency repetitions of the legacy S-SSB), for example, because the quality of radio link meets a predetermined threshold or in response to other conditions, such as operation in a low power or power conversation mode. Alternatively, the receiver UE may choose or be configured to implement combination of frequency repetitions, for example, when signal quality is lower than the predetermined threshold or when operating in a high performance state (e.g., not a power conservation mode or the like).

### Example Operations of a User Equipment

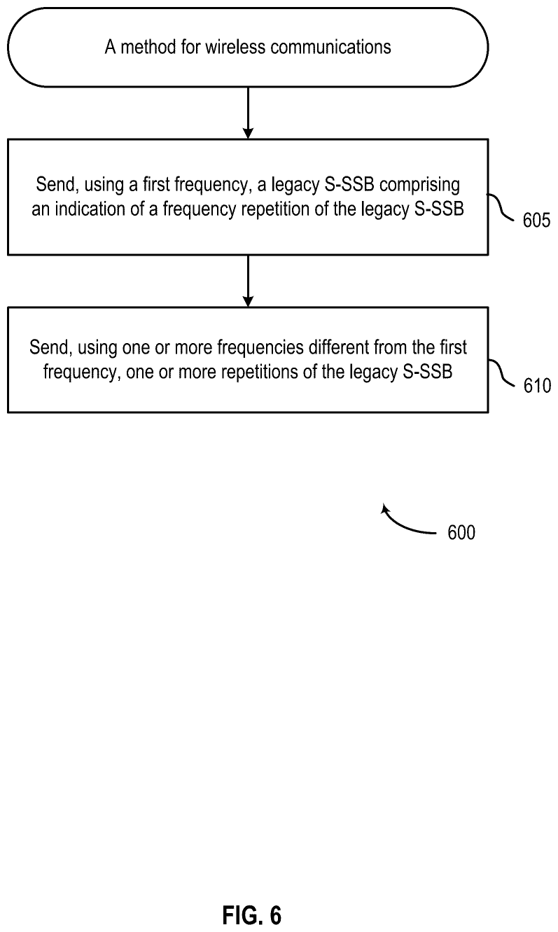

FIG. 6 shows a method 600 for wireless communication by an apparatus, such as UE 104 of FIGS. 1 and 3. For example, UE 104 may be a transmit UE described herein that is capable of transmitting an indication of frequency repetitions of the legacy S-SSB and further transmitting the frequency repetitions of the legacy S-SSB for synchronization functions with other UEs for sidelink communications.

Method 600 begins at step 605 with sending, using a first frequency, a legacy S-SSB comprising an indication of a frequency repetition of the legacy S-SSB.

Method 600 then proceeds to step 610 with sending, using one or more frequencies different from the first frequency, one or more repetitions of the legacy S-SSB. For example, as shown in FIG. 5, the frequency repetitions of the legacy S-SSB 502, 503A-C occur across a channel bandwidth 504.

In one aspect, method 600 further includes determining to send the one or more repetitions of the legacy S-SSB in order to meet an occupied channel bandwidth threshold. For example, the occupied channel bandwidth may be the channel bandwidth 504 depicted in FIG. 5.

In one aspect, method 600 further includes determining to send the one or more repetitions of the legacy S-SSB in order to achieve a higher transmit power under a power spectral density limit. An effect of sending one or more repetitions of the legacy S-SSB enables a transmitter UE to provide a higher total power associated with the transmitted legacy S-SSB when combined across the frequency domain in which the repetitions are sent while meeting the power spectral density limit for each frequency the one or more repetitions of the legacy S-SSB are transmitted on.

In one aspect, the indication of the frequency repetition of the legacy S-SSB comprises a single bit. The single bit indication of the frequency repetition of the legacy S-SSB enables indication with minimal impact to the data required for providing the indication. The technical effect being that there is an indication of either frequency repetition of the legacy S-SSB or not.

In one aspect, the indication of the frequency repetition of the legacy S-SSB indicates a number of repetitions of the legacy S-SSB.

In one aspect, the indication of the frequency repetition of the legacy S-SSB comprises multiple bits. While using multiple bits for indication of the frequency repetition of the legacy S-SSB may result in a larger amount of data to provide the indication as the single bit, the multiple bits convey additional information to the receiver UE, such as the number of repetitions of the legacy S-SSB which will be present so the receiver UE may properly configure itself to receive, search for, and/or combine the frequency repetitions of the legacy S-SSB.

In one aspect, method 600 further includes determining to send a number of repetitions of the legacy S-SSB.

In one aspect, method 600 further includes determining a number of bits for the indication required to indicate the number of repetitions of the legacy S-SSB.

In one aspect, the indication of the frequency repetition of the legacy S-SSB is comprised within a PSBCH transmission.

In one aspect, the indication of the frequency repetition of the legacy S-SSB is comprised within a MIB.

In one aspect, the indication of the frequency repetition of the legacy S-SSB is comprised within a demodulation reference signal sequence sent on a physical sidelink broadcast channel.

In one aspect, the demodulation reference signal sequence is a scrambled demodulation reference signal sequence.

In one aspect, the one or more repetitions of the legacy S-SSB do not include the indication of the frequency repetition of the legacy S-SSB.

In one aspect, each of the one or more repetitions of the legacy S-SSB is separated by a predefined frequency gap. The predefined frequency gap are implemented to define the bandwidth outside of the channel which, for example, may contain only 1% of the emissions per occupied channel bandwidth requirements, so that frequency repetitions of the legacy S-SSB meet the occupied channel bandwidth threshold.

In one aspect, method 600 further includes selecting the predefined frequency gap in order to meet an occupied channel bandwidth threshold.

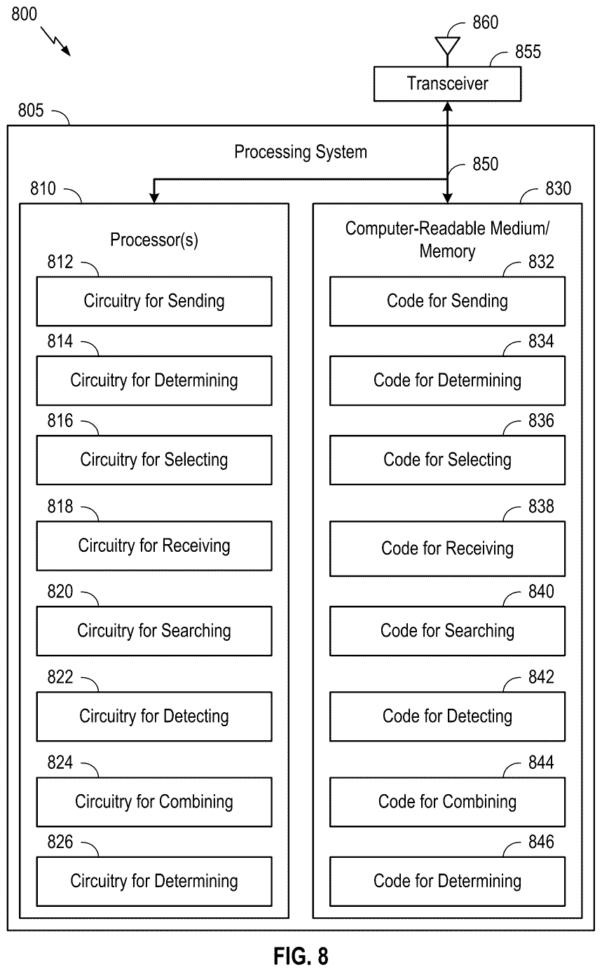

In one aspect, method 600, or any aspect related to it, may be performed by an apparatus, such as communications device 800 of FIG. 8, which includes various components operable, configured, or adapted to perform the method 600. Communications device 800 is described below in further detail.

Note that FIG. 6 is just one example of a method, and other methods including fewer, additional, or alternative steps are possible consistent with this disclosure.

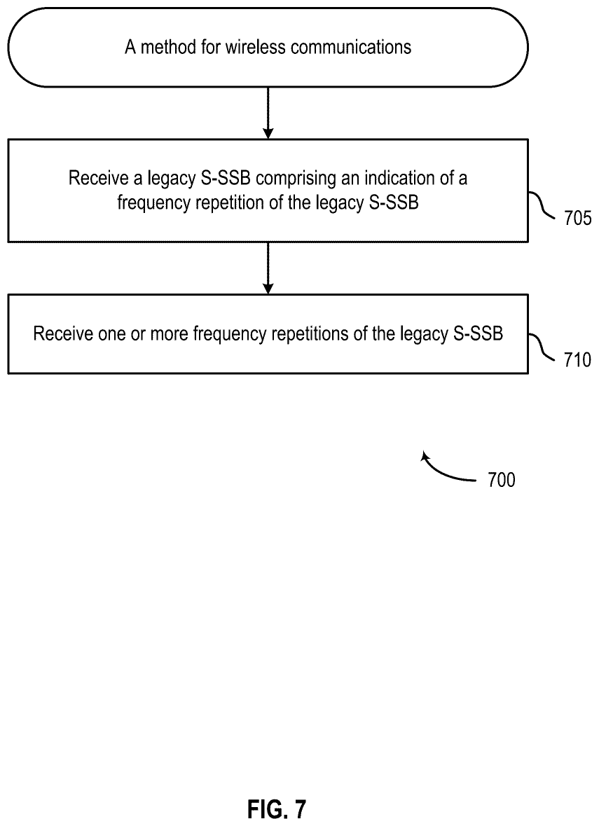

FIG. 7 shows a method 700 for wireless communication by an apparatus, such as UE 104 of FIGS. 1 and 3. For example, UE 104 may be a receiver UE described herein that is capable of receiving an indication of frequency repetitions of the legacy S-SSB and utilizing the frequency repetitions of the legacy S-SSB for synchronization functions with other UEs for sidelink communications.

Method 700 begins at step 705 with receiving a legacy S-SSB comprising an indication of a frequency repetition of the legacy S-SSB. The indication of the frequency repetition of the legacy S-SSB conveys to a receiver UE that synchronization information will be transmitted across the frequency domain as opposed to merely within a preconfigured synchronization raster. The indication further enables the receiver UE to reconfigure its search for and monitoring of instances of the legacy S-SSB to include frequencies outside of the preconfigured synchronization raster.

Method 700 then proceeds to step 710 with receiving one or more frequency repetitions of the legacy S-SSB. For example, as shown in FIG. 5, the frequency repetitions of the legacy S-SSB 502, 503A-C occur across a channel bandwidth 504.

In one aspect, method 700 further includes searching for the legacy S-SSB on a predefined synchronization raster for the indication.

In one aspect, method 700 further includes detecting the indication of the frequency repetition in the legacy S-SSB.

In one aspect, method 700 further includes combining the one or more frequency repetitions based on detection of the indication. In some aspects, once a receiver UE (e.g., UE 104 of FIGS. 1 and 3) detects the indication of frequency repetitions in the legacy S-SSB, the received UE may combine frequency repetitions of the legacy S-SSB. Operationally, a combination of frequency repetitions of the legacy S-SSB can result in an increase in the total power of the received legacy S-SSBs which may improve the ability for the receiver UE to decode the synchronization information, for example, to meet a detection threshold required for utilizing the synchronization information. An increase in the total power of the received legacy S-SSBs may be required to improve the effective coverage area of sidelink communications between UEs as the strength and quality of a signal attenuates with distance.

In one aspect, method 700 further includes detecting the indication of the frequency repetition of the legacy S-SSB.

In one aspect, method 700 further includes determining not to combine the one or more frequency repetitions based on detection of the indication. For example, the receiver UE (e.g., UE 104 of FIGS. 1 and 3) may not execute a process of combining the one or more frequency repetitions of the legacy S-SSB because an initial instance may be sufficient (e.g., meet the detection threshold) for utilizing the synchronization information provided with the legacy S-SSB. To that effect, the receiver UE may avoid executing unnecessary processes in establishing and/or maintaining sidelink communications with one or more other UEs (e.g., UE 104 of FIGS. 1 and 3).

In one aspect, method 700, or any aspect related to it, may be performed by an apparatus, such as communications device 800 of FIG. 8, which includes various components operable, configured, or adapted to perform the method 700. Communications device 900 is described below in further detail.

Note that FIG. 7 is just one example of a method, and other methods including fewer, additional, or alternative steps are possible consistent with this disclosure.

### Example Communications Device

FIG. 8 depicts aspects of an example communications device 800. In some aspects, communications device 800 is a user equipment, such as UE 104 described above with respect to FIGS. 1 and 3. UE 104 is a sidelink capable UE.

The communications device 800 includes a processing system 805 coupled to a transceiver 855 (e.g., a transmitter and/or a receiver). The transceiver 855 is configured to transmit and receive signals for the communications device 800 via an antenna 860, such as the various signals as described herein. The processing system 805 may be configured to perform processing functions for the communications device 800, including processing signals received and/or to be transmitted by the communications device 800.

The processing system 805 includes one or more processors 810. In various aspects, the one or more processors 810 may be representative of one or more of receive processor 358, transmit processor 364, TX MIMO processor 366, and/or controller/processor 380, as described with respect to FIG. 3. The one or more processors 810 are coupled to a computer-readable medium/memory 830 via a bus 850. In certain aspects, the computer-readable medium/memory 830 is configured to store instructions (e.g., computer-executable code) that when executed by the one or more processors 810, enable and cause the one or more processors 810 to perform the method 600 described with respect to FIG. 6, or any aspect related to it, including any additional steps or sub-steps described in relation to FIG. 6; and the method 700 described with respect to FIG. 7, or any aspect related to it, including any additional steps or sub-steps described in relation to FIG. 7. Note that reference to a processor performing a function of communications device 800 may include one or more processors performing that function of communications device 800, such as in a distributed fashion.

In the depicted example, computer-readable medium/memory 830 stores code for sending 832, code for determining 834, code for selecting 836, code for receiving 838, code for searching 840, code for detecting 842, code for combining 844, and code for determining 846. Processing of the code 832-846 may enable and cause the communications device 800 to perform the method 600 described with respect to FIG. 6, or any aspect related to it; and/or the method 700 described with respect to FIG. 7, or any aspect related to it.

The one or more processors 810 include circuitry configured to implement (e.g., execute) the code stored in the computer-readable medium/memory 830, including circuitry for sending 812, circuitry for determining 814, circuitry for selecting 816, circuitry for receiving 818, circuitry for searching 820, circuitry for detecting 822, circuitry for combining 824, and circuitry for determining 826. Processing with circuitry 812-826 may enable and cause the communications device 800 to perform the method 600 described with respect to FIG. 6, or any aspect related to it; and/or the method 700 described with respect to FIG. 7, or any aspect related to it.

More generally, means for communicating, transmitting, sending or outputting for transmission may include the transceivers 354, antenna(s) 352, transmit processor 364, TX MIMO processor 366, and/or controller/processor 380 of the UE 104 illustrated in FIG. 3, transceiver 855 and/or antenna 860 of the communications device 800 in FIG. 8, and/or one or more processors 810 of the communications device 800 in FIG. 8. Means for communicating, receiving or obtaining may include the transceivers 354, antenna(s) 352, receive processor 358, and/or controller/processor 380 of the UE 104 illustrated in FIG. 3, transceiver 855 and/or antenna 860 of the communications device 800 in FIG. 8, and/or one or more processors 810 of the communications device 800 in FIG. 8.

### Example Clauses

Implementation examples are described in the following numbered clauses:

Clause 1: A method for wireless communications by an apparatus, comprising: sending, using a first frequency, a legacy S-SSB comprising an indication of a frequency repetition of the legacy S-SSB; and sending, using one or more frequencies different from the first frequency, one or more repetitions of the legacy S-SSB.

Clause 2: The method of Clause 1, further comprising determining to send the one or more repetitions of the legacy S-SSB in order to meet an occupied channel bandwidth threshold.

Clause 3: The method of any one of Clauses 1-2, further comprising determining to send the one or more repetitions of the legacy S-SSB in order to achieve a higher transmit power under a power spectral density limit.

Clause 4: The method of any one of Clauses 1-3, wherein the indication of the frequency repetition of the legacy S-SSB comprises a single bit.

Clause 5: The method of any one of Clauses 1-4, wherein the indication of the frequency repetition of the legacy S-SSB indicates a number of repetitions of the legacy S-SSB.

Clause 6: The method of any one of Clauses 1-5, wherein the indication of the frequency repetition of the legacy S-SSB comprises multiple bits.

Clause 7: The method of any one of Clauses 1-6, further comprising: determining to send a number of repetitions of the legacy S-SSB; and determining a number of bits for the indication required to indicate the number of repetitions of the legacy S-SSB.

Clause 8: The method of any one of Clauses 1-7, wherein the indication of the frequency repetition of the legacy S-SSB is comprised within a PSBCH transmission.

Clause 9: The method of any one of Clauses 1-8, wherein the indication of the frequency repetition of the legacy S-SSB is comprised within a MIB.

Clause 10: The method of any one of Clauses 1-9, wherein the indication of the frequency repetition of the legacy S-SSB is comprised within a demodulation reference signal sequence sent on a physical sidelink broadcast channel.

Clause 11: The method of Clause 10, wherein the demodulation reference signal sequence is a scrambled demodulation reference signal sequence.

Clause 12: The method of any one of Clauses 1-11, wherein the one or more repetitions of the legacy S-SSB do not include the indication of the frequency repetition of the legacy S-SSB.

Clause 13: The method of any one of Clauses 1-12, wherein each of the one or more repetitions of the legacy S-SSB is separated by a predefined frequency gap.

Clause 14: The method of Clause 13, further comprising selecting the predefined frequency gap in order to meet an occupied channel bandwidth threshold.

Clause 15: A method for wireless communications by an apparatus, comprising: receiving a legacy S-SSB comprising an indication of a frequency repetition of the legacy S-SSB; and receiving one or more frequency repetitions of the legacy S-SSB.

Clause 16: The method of Clause 15, further comprising: searching for the legacy S-SSB on a predefined synchronization raster for the indication.

Clause 17: The method of any one of Clauses 15-16, further comprising: detecting the indication of the frequency repetition in the legacy S-SSB; and combining the one or more frequency repetitions based on detection of the indication.

Clause 18: The method of any one of Clauses 15-17, further comprising: detecting the indication of the frequency repetition of the legacy S-SSB; and determining not to combine the one or more frequency repetitions based on detection of the indication.

Clause 19: A network entity configured for wireless communications, comprising: one or more memories comprising processor-executable instructions; and one or more processors configured to execute the processor-executable instructions and cause the network entity to send a configuration defining a number of repetitions for a user equipment to transmit based on a number of SyncRef nodes in a network.

Clause 20: The network entity of Clause 19, wherein the number of repetitions is greater for a first network comprising a first number of SyncRef nodes than a second network comprising a second number of SyncRef nodes, the first number of SyncRef nodes is less than the second number of SyncRef nodes.

Clause 21: One or more apparatuses, comprising: one or more memories comprising executable instructions; and one or more processors configured to execute the executable instructions and cause the one or more apparatuses to perform a method in accordance with any one of clauses 1-20.

Clause 22: One or more apparatuses, comprising means for performing a method in accordance with any one of clauses 1-20.

Clause 23: One or more non-transitory computer-readable media comprising executable instructions that, when executed by one or more processors of one or more apparatuses, cause the one or more apparatuses to perform a method in accordance with any one of clauses 1-20.

Clause 24: One or more computer program products embodied on one or more computer-readable storage media comprising code for performing a method in accordance with any one of clauses 1-20.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

1. An apparatus configured for wireless communications, comprising one or more memories coupled to one or more processors, wherein the one or more processors are configured to cause the apparatus to:
send, using a first frequency, a legacy sidelink synchronization signal block (S-SSB) comprising an indication of a frequency repetition of the legacy S-SSB; and
send, using one or more frequencies different from the first frequency, one or more repetitions of the legacy S-SSB.

2. The apparatus of claim 1, wherein the one or more processors are further configured to cause the apparatus to determine to send the one or more repetitions of the legacy S-SSB in order to meet an occupied channel bandwidth threshold.

3. The apparatus of claim 1, wherein the one or more processors are further configured to cause the apparatus to determine to send the one or more repetitions of the legacy S-SSB in order to achieve a higher transmit power under a power spectral density limit.

4. The apparatus of claim 1, wherein the indication of the frequency repetition of the legacy S-SSB comprises a single bit.

5. The apparatus of claim 1, wherein the indication of the frequency repetition of the legacy S-SSB indicates a number of repetitions of the legacy S-SSB.

6. The apparatus of claim 1, wherein the indication of the frequency repetition of the legacy S-SSB comprises multiple bits.

7. The apparatus of claim 1, wherein the one or more processors are further configured to cause the apparatus to:
determine to send a number of repetitions of the legacy S-SSB, and
determine a number of bits for the indication required to indicate the number of repetitions of the legacy S-SSB.

8. The apparatus of claim 1, wherein the indication of the frequency repetition of the legacy S-SSB is comprised within a physical sidelink broadcast channel (PSBCH) transmission.

9. The apparatus of claim 1, wherein the indication of the frequency repetition of the legacy S-SSB is comprised within a master information block (MIB).

10. The apparatus of claim 1, wherein the indication of the frequency repetition of the legacy S-SSB is comprised within a demodulation reference signal sequence sent on a physical sidelink broadcast channel.

11. The apparatus of claim 10, wherein the demodulation reference signal sequence is a scrambled demodulation reference signal sequence.

12. The apparatus of claim 1, wherein the one or more repetitions of the legacy S-SSB do not include the indication of the frequency repetition of the legacy S-SSB.

13. The apparatus of claim 1, wherein each of the one or more repetitions of the legacy S-SSB is separated by a predefined frequency gap.

14. The apparatus of claim 13, wherein the one or more processors are further configured to cause the apparatus to select the predefined frequency gap in order to meet an occupied channel bandwidth threshold.

15. An apparatus configured for wireless communications, comprising one or more memories coupled to one or more processors, wherein the one or more processors are configured to cause the apparatus to:
receive a legacy sidelink synchronization signal block (S-SSB) comprising an indication of a frequency repetition of the legacy S-SSB; and
receive one or more frequency repetitions of the legacy S-SSB.

16. The apparatus of claim 15, wherein the one or more processors are configured to execute the processor-executable instructions that further cause the apparatus to search for the legacy S-SSB on a predefined synchronization raster for the indication.

17. The apparatus of claim 15, wherein the one or more processors are configured to execute the processor-executable instructions that further cause the apparatus to: detect the indication of the frequency repetition in the legacy S-SSB; and combine the one or more frequency repetitions based on detection of the indication.

18. The apparatus of claim 15, wherein the one or more processors are configured to execute the processor-executable instructions that further cause the apparatus to: detect the indication of the frequency repetition of the legacy S-SSB; and determine not to combine the one or more frequency repetitions based on detection of the indication.

19. A method for wireless communications by an apparatus, comprising:
sending, using a first frequency, a legacy sidelink synchronization signal block (S-SSB) comprising an indication of a frequency repetition of the legacy S-SSB; and
sending, using one or more frequencies different from the first frequency, one or more repetitions of the legacy S-SSB.

20. (canceled)

21. (canceled)

22. (canceled)

23. (canceled)

24. (canceled)

25. (canceled)

26. (canceled)

27. (canceled)

28. (canceled)

29. (canceled)

30. (canceled)
